(19) United States
(12) Patent Application Publication
(10) Pub. No.: US 2015/0007752 A1
(43) Pub. Date: Jan. 8, 2015

(54) COMPOSITIONS COMPRISING PHASE CHANGE MATERIAL AND CONCRETE AND USES THEREOF

(71) Applicants: THE REGENTS OF THE UNIVERSITY OF CALIFORNIA, Oakland, CA (US); ARIZONA BOARD OF REGENTS, Tempe, AZ (US)

(72) Inventors: Gaurav Sant, Los Angeles, CA (US); Narayanan Neithalath, Chandler, AZ (US)

(21) Appl. No.: 14/378,957

(22) PCT Filed: Feb. 15, 2013
(86) PCT No.: PCT/US2013/026489

§ 371 Date: Aug. 14, 2014

Related U.S. Application Data
(60) Provisional application No. 61/600,463, filed on Feb. 17, 2012.

(51) Int. Cl. C04B 24/00; C04B 22/00

(52) U.S. Cl. CPC C04B 24/00; C04B 22/00
USPC 106/672; 106/638; 106/705; 106/789

(57) ABSTRACT

Provided herein are compositions comprising concrete and one or more phase change materials (PCMs) for prevention or reduction of thermal damage in a cementitious system, and uses thereof.

### CROSS REFERENCE TO RELATED APPLICATION

This application claims benefit under 35 U.S.C. §119(e) of U.S. provisional application No. 61/600,463 filed on Feb. 17, 2012, the content of which is incorporated herein in its entirety by reference.

### FIELD OF THE INVENTION

Provided herein are compositions comprising concrete and one or more phase change materials (PCMs), and their uses, for example, in preventing or reducing thermal damage in a cementitious system.

### STATE OF THE ART

There is a need to develop thermal damage resistant and energy-efficient materials for building structures and infrastructure facilities.

### SUMMARY

In one aspect, provided herein is a composition comprising concrete and one or more PCMs for prevention or reduction of thermal damage in a cementitious system.

In another aspect, provided herein is a composition for controlling heat of hydration related thermal excursions in a cementitious system, the composition comprising concrete and one or more PCMs.

In one embodiment, the thermal damage comprises:
early-age thermal cracking, long-term fatigue damage, and/or freeze-thaw damage, and/or the damage is related to incompatibilities between thermal excursions between:
a cement paste and the aggregate fractions of concrete and/or
concrete and its restraining and/or supporting element.

In one embodiment, the cementitious system is a hydrating or well-hydrated cementitious system.

In another embodiment, the concrete comprises stratified PCM layers. In another embodiment, the PCM in adjacent PCM layers are the same and/or different.

In another embodiment, the composition has a compressive strength of 500-25,000 psi. In another embodiment, the composition has a compressive strength of 1,000-20,000 psi. In some embodiments, a non-PCM material, non limiting examples of which include quartz, silica fume, fly-ash, blast furnace slags, natural pozzolans, and the likes, may be further included in the compositions provided herein to increase the compressive strength of compositions provided herein. In some embodiments, compositions provided here that further comprise silica fumes can improve the elastic modulus (E) of the composition.

In another embodiment, the composition further comprises one or more of fly-ash, slag, quartz, silica fume, a porous material such as both natural and manufactured lightweight aggregate inclusions of a porous nature, which are able to serve as reservoirs for the PCM, and either non-porous or slightly porous materials such as commonly used aggregates comprised of granite, limestone, etc.

In another embodiment, the PCM is a liquid that is included in a porous, inorganic, aggregate reservoir.

In another embodiment, the PCM is a solid that can undergo a phase transition to another state, such as a liquid. In another embodiment, the PCM is a liquid that can undergo a phase transition to another state, such as a solid.

In another embodiment, the PCM is of an organic nature. Non-limiting examples of organic PCMs include wax or paraffins, polyols, such as trimethylol ethane, and fatty acids, such as lauric acid. In another embodiment, the PCM is an inorganic PCM. Non-limiting examples of inorganic PCMs include salt hydrates and molten salts. Other examples of PCMs are described for example in Sharma et al., Renewable and Sustainable Energy Reviews 13 (2009) 318345.

In some embodiments, the PCM comprises a microcricapsulated structure, wherein the PCM is encapsulated within a shell. In some embodiments, the shells are generally stable or substantially stable to the mixing with cementitious material to the extent that the encapsulated PCMs retain their desired properties.

In some embodiments, the composition is a paste. In other embodiments, the composition is a mortar. In some embodiments, the composition is a concrete composition.

In another embodiment, the % of PCM in the compositions provided herein, by volume, is 0.5% to 50%, 1 to 30%, 2 to 20%, or 3 to 10%. In some embodiments, the volume and/or the dispersion of the PCM in the compositions provided herein are controlled in providing the benefits provided herein.

In other embodiments, the thermal damage is controlled for thermal excursions in sub-ambient and above-ambient temperatures. In another embodiment, the thermal damage is controlled for thermal excursions in the range of −15° C. to 70° C., measured in the composition. In another embodiment, the thermal damage is controlled for thermal excursions in the range of 15° C. or less. In another embodiment, the thermal damage is controlled for thermal excursions in the range of 15° C. or more, or of 20° C. to 50° C.

In another embodiment, the PCM shows a phase transition in the range of −15° C. to 65° C. In another embodiment, the PCM shows a phase transition in the range of 5° C. to 65° C. In another embodiment, the PCM has a phase transition temperature close to the freezing point of water, such as, for example, −15° C. to 10° C., −5° C. to 5° C., or −3° C. to 3° C.

In another embodiment, the PCM Shows a phase transition enthalpy of 20 joules/g to 500 joules/g. In another embodiment, the PCM shows a phase transition enthalpy of 80 joules/g to 300 joules/g.

In another aspect, provided herein is a cementitious structure comprising the composition provided herein, wherein the structure has a high surface to volume ratio and is selected from a floor, a parking lot, and a side walk pavements, slab on grade, bridge decks, and the likes, and from girders, mass concrete sections including columns, bridge piers, dam elements, and the likes.

In another aspect, provided herein is a cementitious structure comprising the composition provided herein, wherein the structure has a large concrete section and is selected from girder darns, and concrete sections including columns, bridge piers, and the likes.

As used herein a “phase change material” or PCM refers to a material that is capable of storing latent heat in the form of thermal energy corresponding to the phase transition temperature of that phase change material (PCM). Phase change can be in the following forms: solid-solid, solid-liquid solid-gas, liquid-gas and vice versa.

### BRIEF DESCRIPTION OF FIGURES

FIG. 1 graphically illustrates the comparative latent heat storage capacity of compositions provided herein.

FIG. 2 graphically illustrates the comparative effect of PCMs on cement reaction rates of compositions provided herein. As used herein, w/c refers to water content and w/p refers to water-to-solid powder content, both as determined on a mass basis.

FIG. 3 graphically illustrates comparative isothermal calorimetry of certain compositions provided herein.

FIG. 4 graphically illustrates the comparative effect of compositions provided herein vis-à-vis temperature rises in cylindrical geometries.

FIG. 5 illustrates that PCMs limit temperature rise and cool-down in cementitious compositions.

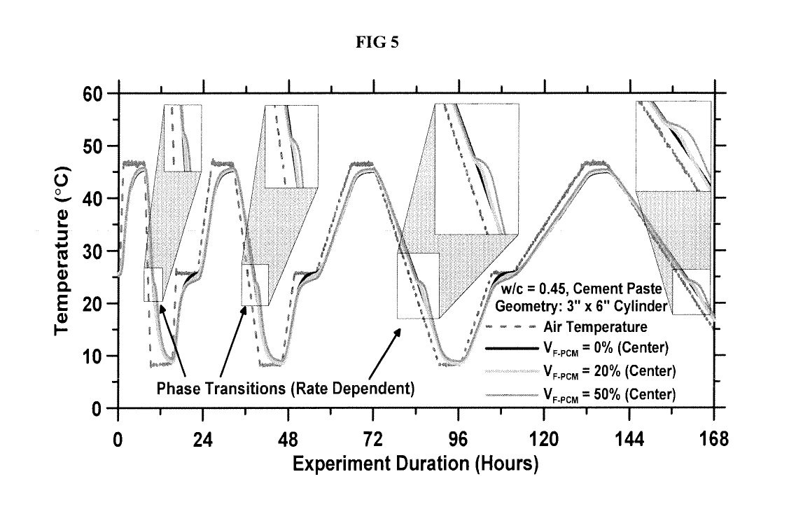

FIG. 6 graphically illustrates that heat transfer of compositions provided herein is temperature rate dependent.

FIGS. 7A, 7B, and 7C graphically illustrate the comparative strength evolution of compositions provided herein.

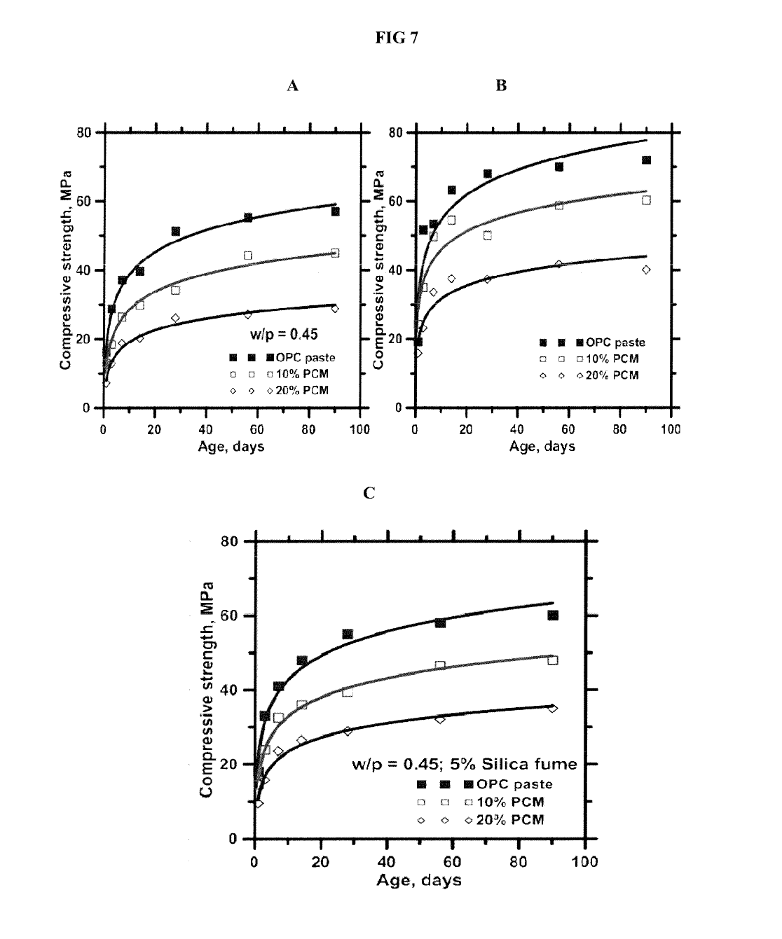

FIG. 8 graphically illustrates the comparative effect of PCMs on compressive strength in a paste composition provided herein.

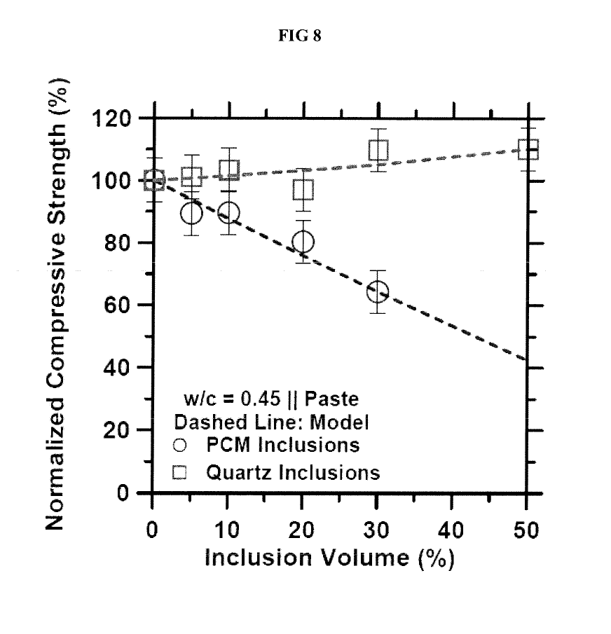

FIG. 9 graphically illustrates the comparative compressive strengths of compositions provided herein with and without silica fume (SF).

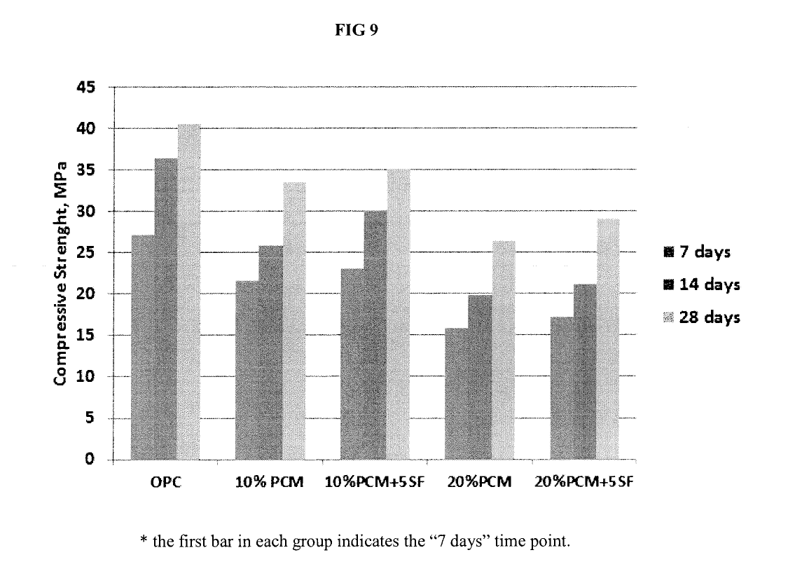

FIGS. 10A and 10B graphically illustrate the elastic modulus of compositions provided herein.

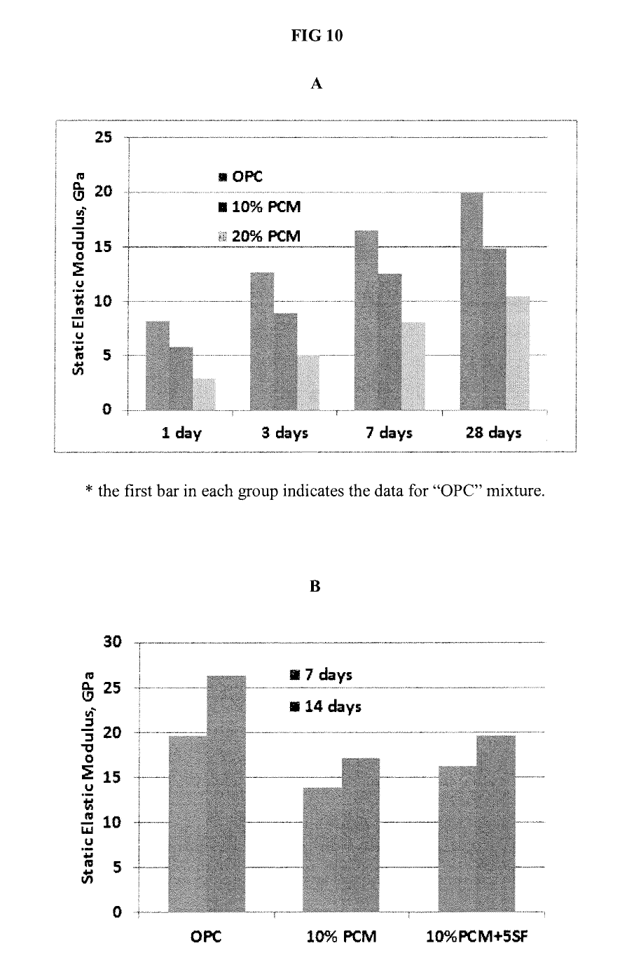

FIG. 11 graphically illustrates the reduction in the magnitude of the thermal stress in concrete containing no PCM.

FIG. 12 graphically illustrates the fracture response of notched beams.

FIG. 13 graphically illustrates the provision of PCM incorporated concrete compositions capable of comparable fracture toughness as that of conventional concretes.

FIGS. 14A and 14 B graphically illustrate that critical crack opening and crack tip opening displacement can be modulated by the addition of SF for PCM incorporated concretes.

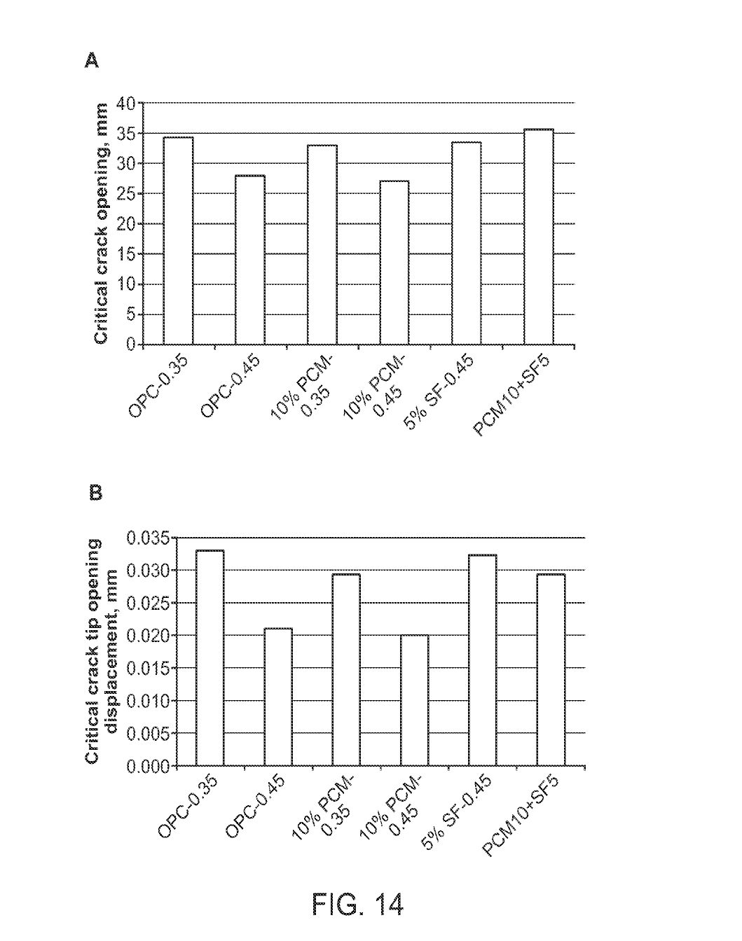

FIG. 15 graphically illustrates the effect of certain paste compositions provided herein on moisture shrinkage.

FIG. 16 graphically illustrate the comparative effect of a composition provided herein on free (thermal) deformation.

FIG. 17 illustrates a dual invar ring setup for restrained thermal evaluations.

FIGS. 18 and 19 graphically illustrate the effect of paste PCM compositions provided herein on thermal stress.

FIG. 20 graphically illustrates the effect of mortar PCM compositions provided herein on thermal stress.

FIG. 21 schematically illustrates certain embodiments comprising striated PCM layers. The PCM in each layer denoted, e.g., by PCM-1, PCM-2, and PCM-3, can be the same or afferent. Phase change property of the PCM can also be same or different in each layer.

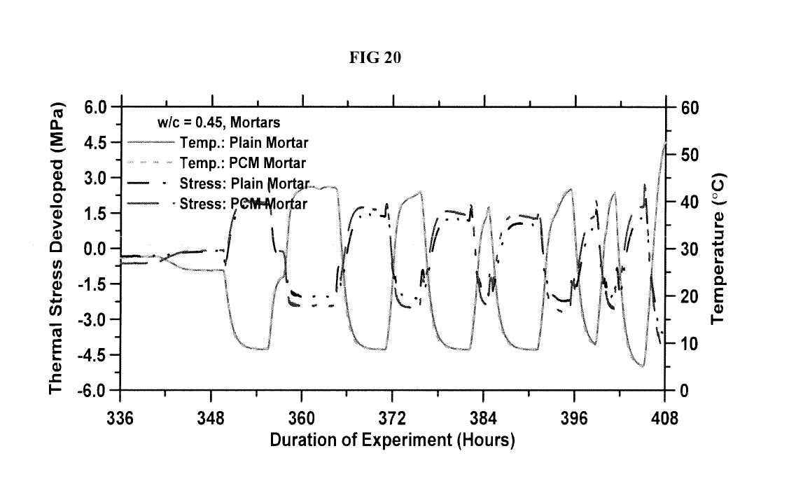

FIG. 22 schematically illustrates certain embodiments where PCM is included in porous aggregates.

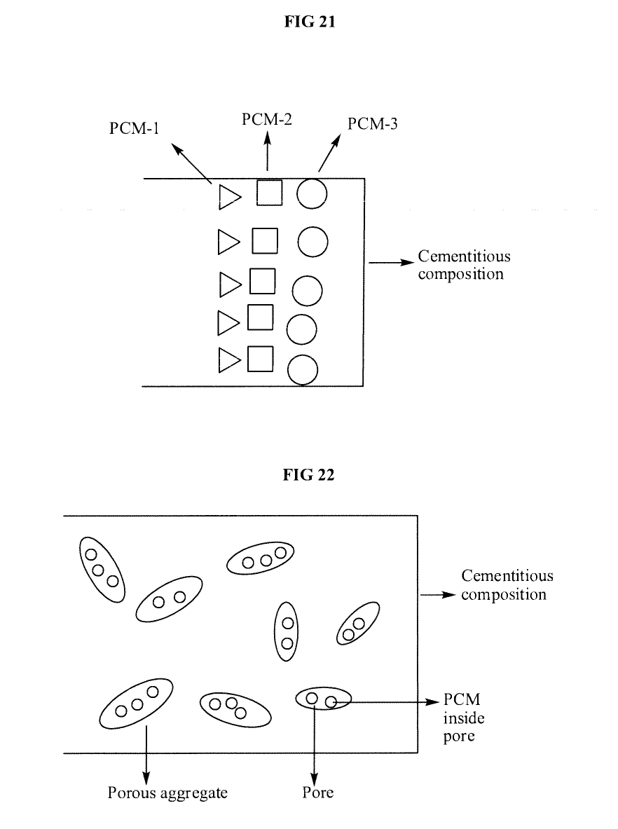

### DETAILED DESCRIPTION

In one aspect, provided herein is a composition comprising concrete and one or more PCMs for prevention or reduction of thermal damage in a cementitious system, wherein the concrete comprises stratified PCM layers, and the thermal damage comprises:
early-age thermal cracking, long-term fatigue damage, and/or freeze-thaw damage, and/or the damage is related to incompatibilities between thermal excursions between:
a cement paste and the aggregate fractions of concrete and/or
concrete and its restraining and/or supporting element.

In another aspect, provided herein is a composition comprising concrete and one or more PCMs for prevention or reduction of thermal damage in a cementitious system, wherein the PCM is a solid, or a liquid, included in a porous, inorganic, aggregate reservoir, and the thermal damage comprises:
early-age thermal cracking, long-term fatigue damage, and/or freeze-thaw damage, and/or the damage is related to incompatibilities between thermal excursions between:
cement paste and the aggregate fractions of concrete and/or
concrete and its restraining and/or supporting element.

Embodiments within the above mentioned aspects are disclosed herein, as will be apparent to the skilled artisan upon reading this disclosure.

In some embodiments, the PCM employed herein comprises or is Micronal® PCM available from BASF Corporation. Micronal® is a PCM, which completes a phase change from solid to liquid at 21° C., 23° C. or 26° C. and vice versa and in doing so can store or release heat Micronal® contains in the core of the microcapsule (size around 5 μm) a latent heat storage material made from a special wax mixture. When there is a rise in temperature above a defined temperature threshold (e.g., 21° C., 23 C or 26° C.), this absorbs the excessive heat energy and stores it in phase change. When the temperature falls below the temperature threshold, the capsule releases this stored heat energy again.

### Improving the Early-Age Thermal Cracking Behavior of Concrete

Cracks can develop in concrete elements when volume changes related to chemical reactions, and thermal or moisture fluctuations are prevented due to end, base, or internal (aggregate) restraint. Early-age thermal cracking can accelerate deterioration, increase maintenance costs, and reduce the service-life of structures.

The thermal cracking susceptibility of a restrained concrete element is dictated by a variety of factors including the: (1) mixture composition of concrete which impacts the heat evolved during the cement reactions, (2) ambient environmental conditions such as wind speed, temperature at placement, and diurnal day-night thermal fluctuations, and (3) geometry (size, shape, aspect ratio) of the concrete element, and the insulation effects of formwork which influences self-heating (and semi-adiabatic temperature increase) and the development of thermal gradients through the cross-section. While these factors can be interrelated, concerns related to the thermal cracking risk may be addressed if the peak (critical) temperature excursion achieved during the cement reactions and the cool down rate can be controlled.

A technology, such as that provided herein, which is capable of reducing the maximum section temperature without affecting the rate of early property development would act to: (1) minimize the temperature/strain gradient by maintaining a uniform temperature through the element's cross section, (2) reduce the magnitude of thermal deformations that may be expected as the section cools down (and contracts) from the time of cast through the diurnal temperature cycle by restricting the maximum temperature rise, and (3) minimize thermal/microstructural effects (temperature rise, gradients and deformations, increased porosity) related to an auto-catalytic acceleration of the cement reaction rate and an increase in section temperature) in a thermally-insulated environment as might occur in the interior of a bridge-pier, large footing or a column. The critical temperature rise, cool-down rate, and the temperature and stress development (gradient and magnitude) inside a structural element depends on the geometry, mechanical degree of restraint, and the concrete mixture proportions and characteristics.

By resisting a temperature change, i.e., by absorbing and releasing heat, PCMs can limit deformations associated with temperature rise, thus limiting critical strain gradients and reducing the risk of thermal cracking at early-ages. The incremental addition of a PCM can progressively suppress temperature rise in a hydrating cementitious system. In some situations, by limiting the peak temperature, the addition of PCMs can also result in an altered cool down rate by reducing the temperature differential between the concrete and the environment. It is also contemplated that cement-PCM composites can be tailored to shift the peak temperature to a later time (age) to allow the concrete to gain strength and better resist cracking.

### Mitigating Long-Term Thermal Fatigue Damage in Concrete Elements

In addition to the early-age benefits mentioned above, PCM-embedment in cementitious materials can provide performance benefits even at longer time-scales. For example: in most cases, the cement paste and aggregate fractions in concrete, and the concrete and structural support elements (girders, beams) have differing thermal deformation coefficients. This results in thermal deformation incompatibilities for a given thermal excursion (heating or cooling) between the paste and the aggregate or the concrete and its restraining/supporting element. When the condition is such that an aggregate inclusion, structural element, or the sub-grade restrains deformations (e.g., as provided by non-shrinking aggregate inclusions in cooling driven shrinkage), tensile stresses develop. When the residual (tensile) stress developed exceeds the strength of the material, cracks develop. A similar effect manifests when a concrete section expands or contracts due to diurnal or seasonal (e.g., freeze-thaw cycling) temperature variations against structural restraint. When thermal deformations and stresses develop repetitively over an extended period (in-service), cyclic loading of this nature induces fatigue-type thermal damage.

By reducing the number of imposed temperature cycles and the cyclic stress range (by limiting the magnitude/extent of temperature change), the addition of PCMs reduces the rate/extent of crack extension in the system. Retarding crack extension makes the material more damage tolerant. The ability to limit fatigue damage is a considerable benefit in extending the service-life of structures.

### Limiting Freeze-Thaw Damage

PCMs and entrained air can act as a two-part freezing protection system for concrete elements. Here, the use of PCMs with a phase transition temperature close to the freezing point of water is contemplated to reduce the number and intensity of freezing events in the system while entrained air would protect against expansive ice crystallization related damage. In addition to improved concrete durability, this approach also offers advantages such as skid resistance, thus adding to the safety of transportation infrastructure.

For concrete pavements, when a PCM-rich concrete layer is placed at the ride surface, it is contemplated to delay the drop in the overall section temperature. In some embodiments, in mild to moderate freezing zones where the temperature drops slightly below the freezing point of water, the heat of solidification of the PCM can be sufficient to consistently maintain PCM-containing concrete elements above the freezing point of the concrete's pore solution.

The potential benefit of PCMs in exposed concrete elements can be illustrated using the following example. In a wet pavement or bridge deck surface with 0.50 kg of freezable-water per square meter, 167 kJ/m² of energy should be supplied to prevent the water from freezing (since the latent heat of fusion of water is 334 kJ/kg. If a PCM with an enthalpy of solidification of 100 kJ/kg is incorporated in the concrete section, 1.67 kg of well-dispersed PCM is included per square meter of the pavement or bridge deck surface to prevent freezing. The required quantity of the PCM can be incorporated as microencapsulated particles or incorporated directly into the porous aggregates akin to internal curing as accomplished using porous reservoirs. The efficiency of the PCM addition would further depend on the properties of the PCM (enthalpy of phase change, phase transition temperature, thermal conductivity), the mode of PCM incorporation and its efficiency of distribution in concrete, and the intensity of imposed freeze-thaw cycles. In some embodiments, doping the PCM with conductive particulate inclusions is contemplated to improve freeze-thaw damage.

### Evaluation of the Material Properties

In some embodiments, organic and non-polar PCMs are employed according to this disclosure. Cementitious mixtures are proportioned with a water-to-cement ratio (w/c) between 0.42 and 0.45 (0.42<w/c<0.45) to ensure that the early-age deformations are purely thermal in nature while neglecting autogenous effects. The characterization of material properties relevant to cementitious composites are performed at intervals of 1, 3, 7, and 28 days. First, the compressive strength of the cementitious systems are determined as per ASTM C39/C109 and the elastic modulus using ultrasonic (compressional-wave) methods. Second, determinations of the isothermal and semi-adiabatic thermal signature of the cementitious mixtures are carried out. This information is used to identify the rate and extent of the cement reaction and the relevant thermal excursion that may be expected in the system. Third, differential scanning calorimetry (DSC) is used to characterize the enthalpy of phase change of the pure PCM and the PCM-cement paste composite. The DSC scans are also used to determine the phase transition temperatures. If the temperature rise under semi-adiabatic conditions is noted to alter the rate of reaction considerably, the material property evaluations of the cementitious formulations is performed at other suitable (lower/higher) curing temperatures to accurately characterize the material properties.

### Delivery Strategies for PCM and the Influence of Pore Structure on Thermal Properties

In some embodiments, microencapsulated PCMs are used in cementitious formulations, Microencapsulated PCMs are available in several particle sizes/shapes that facilitate their direct addition into cement pastes or concretes. In some embodiments liquid-PCMs are incorporated into porous (inorganic) aggregate reservoirs. Such incorporation is performed by employing methods of vacuum saturation or miscibility linked fluid-displacement to impregnate porous media which can serve as thermal regulation devices in concrete. A detailed characterization of the pore volume-and-distribution (using porosimetrie and image analysis methods) of the PCM-host reservoir, and the density, viscosity and surface tension of the PCM is carried out to relate these parameters to the infiltration efficiency. The efficiency of the infiltration process and the suitability of the porous host (e.g., perlite, shale, or ceramic inclusions) is determined based on a maximum-filling criterion, as in general, a larger extent of filling would translate to better heat absorption and release behavior. The infiltration method and porous medium which achieve maximal pore-filling by the PCM are used for further testing. To avoid the movement of the PCM from the pores of the host to the matrix during melting, the porous inclusions in this study are coated with a layer of cement paste after PCM infiltration. As to PCM incorporation in porous lightweight aggregates, vacuum saturation is used at different times, vacuum saturation followed by ambient absorption, and long term ambient absorption. In lightweight aggregates with 25% porosity, 15% incorporation with a PCM is obtained. The porous inclusions, when coated with a layer of cement paste provide 3-day strengths comparable to those of specimens without PCM.

### PCM Volume, Distribution, and Inclusion Method

In some embodiments, the mechanical properties and thermal (isothermal and semi-adiabatic) signatures of cement-PCM composites are evaluated for a variety of PCM parameters. Electron microscopy is used to observe two dimensional microstructures of cement paste-PCM composites.

### Stability of PCMs in the Confinement Medium

In some embodiments, the cementitious system used herein comprises portland cement. Portland cement can, in some embodiments, have an alkaline pH, for example, of >12.7, and contain for example a mixture of sodium and potassium hydroxides. Thus, in some embodiments, the performance of PCMs used in the compositions is determined in contact with deionized water and simulated concrete pore solutions of varying ionic strength when: (1) present in capsules, (2) present as a bulk liquid, and (3) infiltrated into a porous aggregate. In some embodiments, the thermal cycling stability of the PCM are evaluated using DSC measurements to cyclically measure the enthalpy of phase change during heating and cooling cycles. In some embodiments, the PCM-cementitious composites are tested to determine the bulk properties of the PCMs, such as, heat absorption and release, over multiple temperature change cycles.

### Restrained Thermal Cracking Evaluations

In some other embodiments, the ability of PCMs to mitigate thermal stresses and cracking in restrained concrete elements is determined. Instrumented, invar dual-ring setups are used to quantify residual strain/stress development in cement pastes and mortars (with and without PCMs) under realistic (environmental and concrete) temperature conditions. The temperature profiles are generated by: (1) placing the restrained element in an enclosure provided with insulation and/or environmental regulation (temperature and humidity) to mimic semi-adiabatic or ambient environmental conditions, or (2) circulating temperature-conditioned fluids through a thermal conduction assembly maintained in contact with the restrained element. In some embodiments, customizable temperature profiles, peak-mixture temperatures and concrete cool-down rates are determined to test a variety of combinations as related to the mixture proportions, construction methods and environmental conditions.

In some embodiments, the residual stresses are quantified with a focus on: (a) determining the peak (compressive/tensile) stress developed and the rate and extent of (thermal) stress change (reduction) upon PCM addition, (b) the rate of post-setting stress development and the timing of compressive-to-tensile stress reversals, and (e) evaluating the risk (and-time) of thermal cracking based on an assessment of the crack resistance capacity of the material, in some embodiments, a comparison of the elastic and residual stresses are carried out to determine if changes in the thermal environment of the material impact the rate/extent of stress relaxation in materials. These evaluations arc carried out on paste and mortar formulations containing: (i) encapsulated PCM, (ii) PCM in porous inclusions, (iii) liquid PCMs, and (iv) PCM in multiple forms (combination of bulk-liquid, microencapsulated, in porous inclusions), in addition to conventional (non-PCM) mortar specimens.

In some embodiments, the extent of thermal stress reduction is quantified for varying volume additions of PCMs. In addition to early-age evaluations, thermal cycles corresponding to the extreme diurnal temperature variation in different geographical locations are imposed on instrumented mature (after 28 days of curing under sealed conditions) mortar slab/ring geometries under sealed/drying conditions for a minimum period of 90 days (180 beating/cooling cycles). By measuring the mortar temperature at the interior/surface, and quantifying stress (strain) cycling, the ability of PCMs to limit temperature fluctuations, thermal deformations and delay fatigue damage in restrained elements over longer-time scales, by providing multi-cycle phase change relief, is determined. Thus, in some embodiments, the ability of the compositions provided herein to mitigate early-and-later age thermal damage-and-cracking concerns in restrained concrete elements is determined.

### The Effect of PCMs on Freeze-Thaw Related Damage

In some embodiments, the ability of PCMs in reducing the freeze thaw damage propensity of exposed concrete elements is determined. In some embodiments a proper PCM (based on the transition temperature, heat of phase change) and its method of delivery to ensure a suitable dispersion of the PCM in the system are selected. In some embodiments, the PCM type/dosage developed from the DSC studies are integrated with dispersion quantifications to ensure that the PCM-assembly provides self-warming abilities to concrete. It is contemplated that by releasing phase-change linked heat, the PCM can help maintain the pore-solution in the liquid state for a longer duration. In some embodiments, such is beneficial during short, or limited magnitude freezing cycles as the addition of a PCM can act to reduce the number of freeze thaw cycles imposed on the concrete element.

In some embodiments, measurements of the internal and ambient temperature (in PCM incorporated and traditional cementinous systems) are combined with dynamic assessments of thermo-mechanical parameters (volume change with temperature, stiffness loss, heat flow) of specimens saturated to different moisture levels with and without air entraining agents. In some embodiments, the improvement in freeze-thaw behavior in materials exposed to a critical number of freeze-thaw cycles (for a constant moisture level) depending on the formulation. i.e., for conventional concrete, PCM-based concrete, or a concrete containing both PCMs and entrained air is determined. In some embodiments, “bridge-deck” sections for several geographic locations are simulated to be subjected to cyclic freeze-thaw events while mapping the temperature, strain, and the number of freeze-thaw cycles to macroscopic failure (based on reduction in dynamic elastic modulus) expected with and without the use of PCMs. In some embodiments, such results are used to provide calibrated tools which incorporate material models of heat transfer, environmental exposure information, deformation and damage mechanisms, and composite mixture proportioning strategies to predict freeze-thaw behavior and thus to specify PCM-based solutions for freeze-thaw resistant infrastructure.

### Energy Efficiency Evaluations

In some embodiments, the compositions provided here are also useful for reducing the amount of energy required to heat and/or cool a building. Thus employed, the compositions provided herein can ensure heat storage (when the temperature increases as heat is supplied by incident solar radiation) and heat release (when the external environment cools), thereby decreasing the frequency of internal air temperature swings and keeping ambient internal temperatures closer to “optimal” for a longer duration of time.

In some embodiments, instrumented, thermally insulated custom concrete enclosures are built in the laboratory (approximately 1 ft³) to simulate as typical building exterior envelope. Several variations of roof slabs cart include: (1) conventional concrete (or mortar), (2) a conventional concrete sandwich panel containing typical thermal insulation material (such as polystyrene of fiberglass with a R value of 3-to-4 per inch of thickness), (3) a concrete containing encapsulated PCM at a selected dosage, (4) a concrete containing hulk liquid PCM, (5) a concrete where the PCM is contained in porous inclusions, and (6) a concrete containing PCMs in multiple forms, i.e., encapsulated, inclusion contained and bulk liquid. The simulated roof slab are heated cyclically using a light-source for between 10-to-12 hours to simulate daytime solar activity and then switched off to simulate night-time conditions. The simulated day-night cycles are repeated over an extended time-scale to determine the efficiency of each of these systems in thermal cycling related energy-conservation in terms limiting heat-transfer and maintaining fixed conditions inside the enclosure. The enclosures are provided with temperature sensing probes to monitor the internal, surface (wall and roof), and air temperatures. Further, the relative humidity variation in the internal environment will also be monitored.

In some embodiments, PCM cement compositions selected based in part on the methods described herein are used to construct field-scale instrumented roof-slabs for an enclosure (1 m³) along with a conventional concrete slab for comparison. The field-scale tests are conducted in various geographical locations. The temperature history of these exposed enclosures over a long period of time, along with the daily weather data from nearby weather stations, is contemplated to demonstrate the ability of PCMs in concrete to act as energy efficient building envelopes, and the cycling stability of PCMs in concrete under realistic exposure conditions.

This technology having been described in summary and in detail is illustrated and not limited by the examples provided herein. The FIGs provided herein provide results of the tests carried out in accordance with this disclosure, and certain FIGs are specifically referred to while describing the results below.

### EXAMPLES

### Example 1: Materials and Proportions

Water content (w/c)=0.45: Cement pastes and composite mortars. PCM employed Micronal 5008X (as supplied).

| | | | | Overall | Latent | | |
|---|---|---|---|---|---|---|---|
| | | Melting | | storage | heat | | |
| Product | Product | point | Integration | capacity | capacity | Solid | Apparent |
| designation | type | approx. | range | approx. | approx. | content | density |
| DS 5008 | Pulver | 23° C. | 10-30° C. | 135 kJ/kg | 100 kJ/kg | In | Approx. |
| | | | | | | powder | 250-350 kg/m³ |
| | | | | | | form | |

Volume fraction of PCM: 0-50%

Sealed Curing Conditions.

### Example 2: Latent Heat Storage Capacity

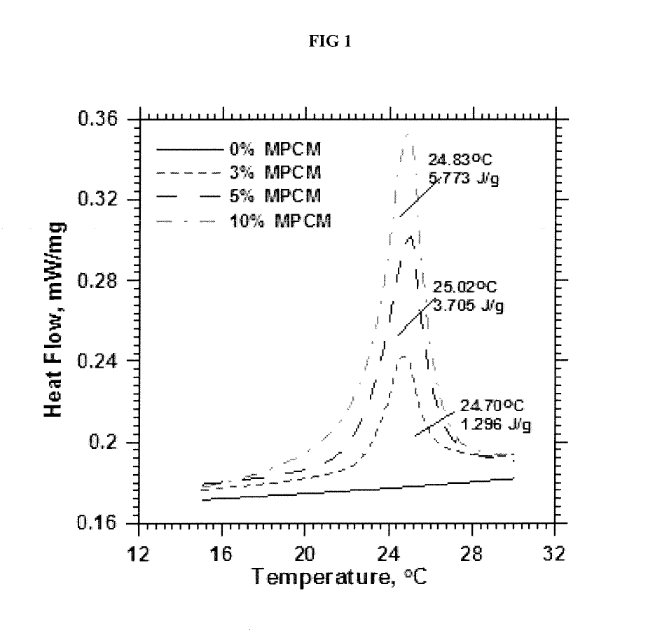

The latent heat storage capacity is shown in FIG. 1 and demonstrates that the enthalpy of the system increases with increased PCM content and that the estimated enthalpy (3.3 kJ/kg) is greater than the observed enthalpy (1.3 kJ/kg).

### Example 3: Effect of PCMs on Cement Reaction Rates

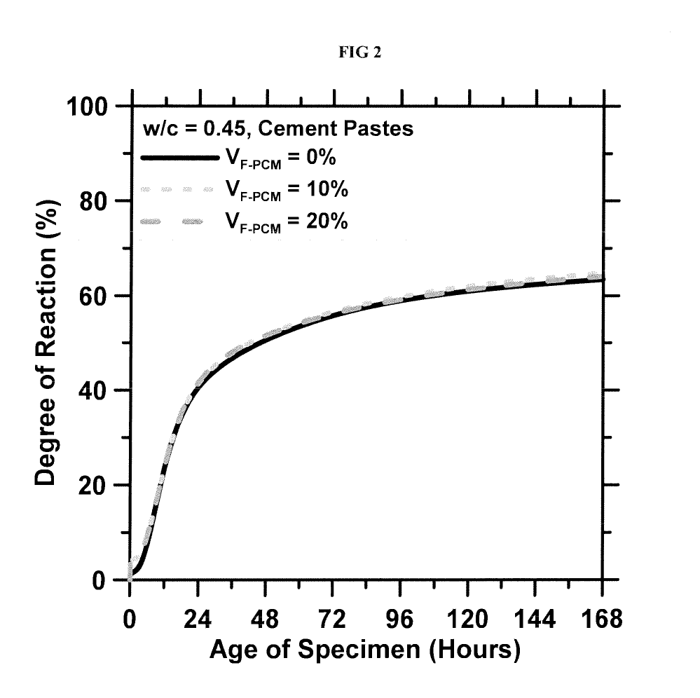

The effect of PCMs on cement reaction rates is determined by isothermal calorimetry using pastes. The results are shown in FIG. 2. The results demonstrate as follows:

PCM additions do not influence rate of reactions;
PCMs do not alter reactions;
Range: 0-20% PCM (by volume).

### Example 4: Isothermal Calorimetry

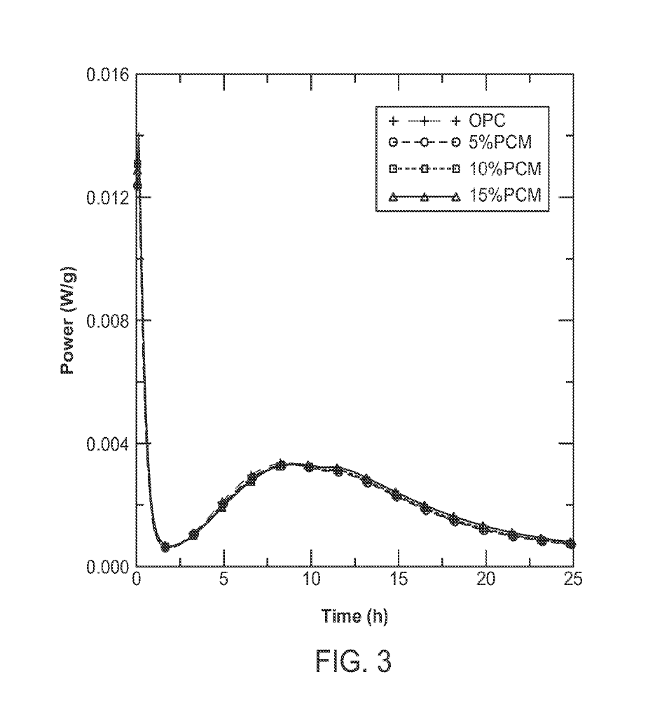

The isothermal calorimetry response of certain compositions provided herein are determined. The results are shown in FIG. 3. The results demonstrate no noticeable change in heat release parameters per unit of cement, at early ages.

### Example 5: Temperature Rise in Cylindrical Geometries

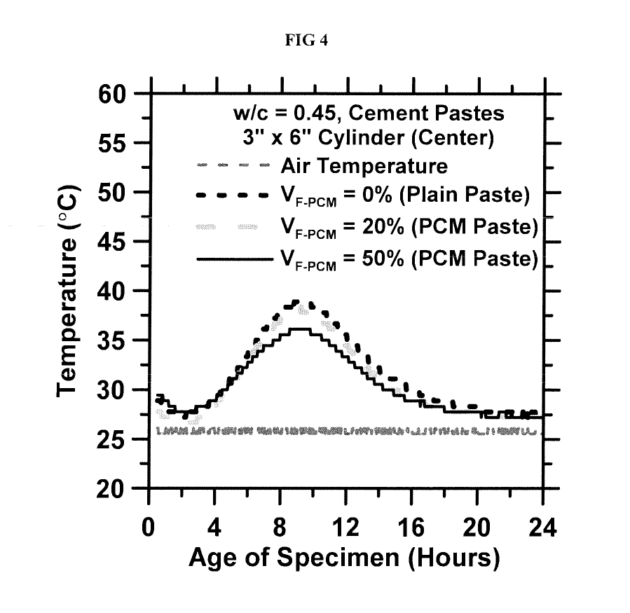

This example measures the effect of compositions provided herein vis-à-vis temperature rise in cylindrical geometries. The results are shown in FIG. 4, and demonstrate as follows.
PCM additions alter temperature rise behavior;
rate of temperature change is similar, until the phase change occurs, as shown on the cool-down ramp, which results in a reduced cool-down rate;
effect scales with percentage of PCM addition (V_{F-PCM}); and
temperature changes can be altered by changing PCM enthalpy and transition temperature

### Example 6: Heat Transfer is Temperature Rate Dependent

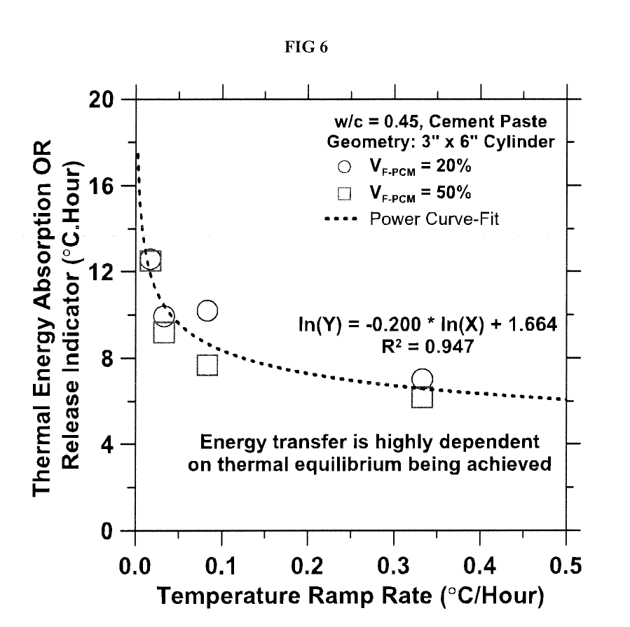

This example demonstrates that PCMs show systematic heat absorption and release. See. FIG. 6. This response is substantially influenced by rate of thermal (temperature) loading. If equilibrium is not achieved, full enthalpy benefit may not be met. The thermo-protective effect of the compositions provided herein may be sensitive to section geometry and thermal conductivity, such that, for example, PCM stratified composites can be useful in some embodiments of the technology as provided herein.

### Example 7: Cyclic Loading: Notched 3-Point Response

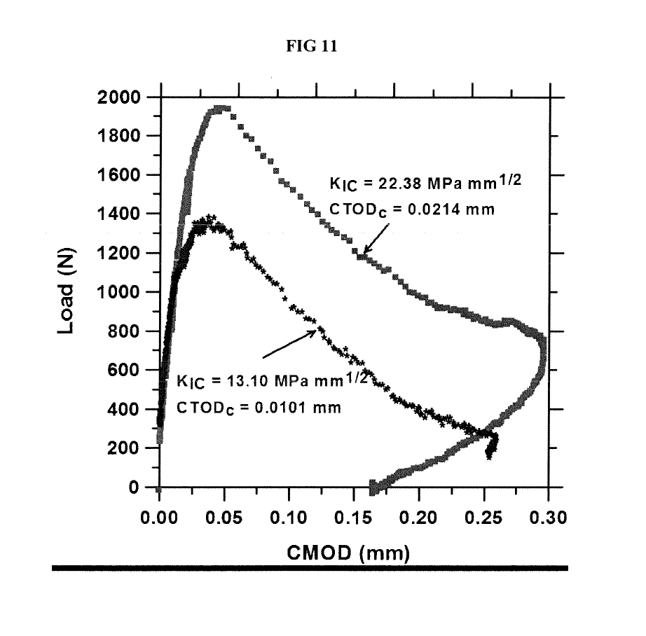

See, FIG. 11. In this test, mechanistic cyclic loading on notched specimens are imposed. Magnitude of applied load is equivalent to “thermally imposed” load (stress level). The size (depth and width) of the notch is varied to simulate damage in material. It is contemplated that the role a PCM plays in reducing the magnitude of the thermal stress in a composition provided herein can be tested in similar ways.

### Example 8: Fracture Response of Notched Beams

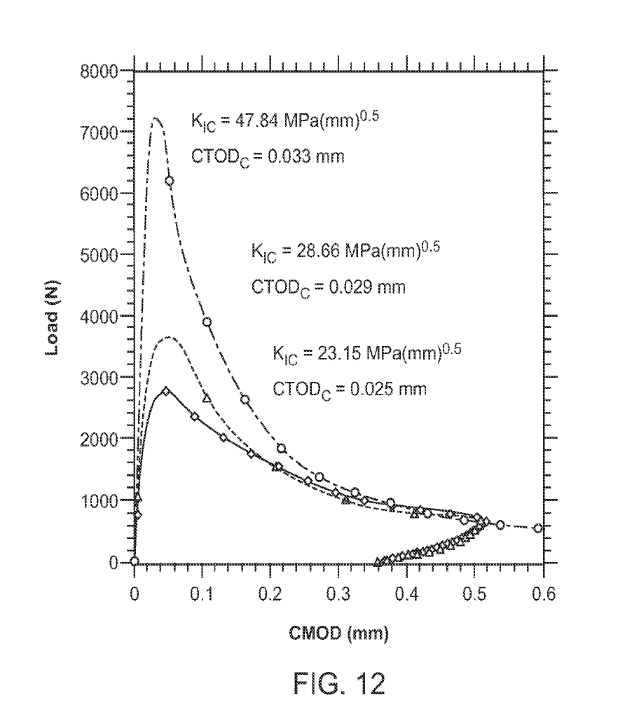

Fracture toughness is determined using a two-parameter fracture model (Jenq and Shah. Journal of Engineering Mechanics, Vol. 111, No. 4, 1985, pp. 1227-1241) With increasing PCM dosage, critical crack tip opening displacements reduce at a lower rate than the fracture toughness. See, FIG. 12.

### Example 9: Fracture Toughness

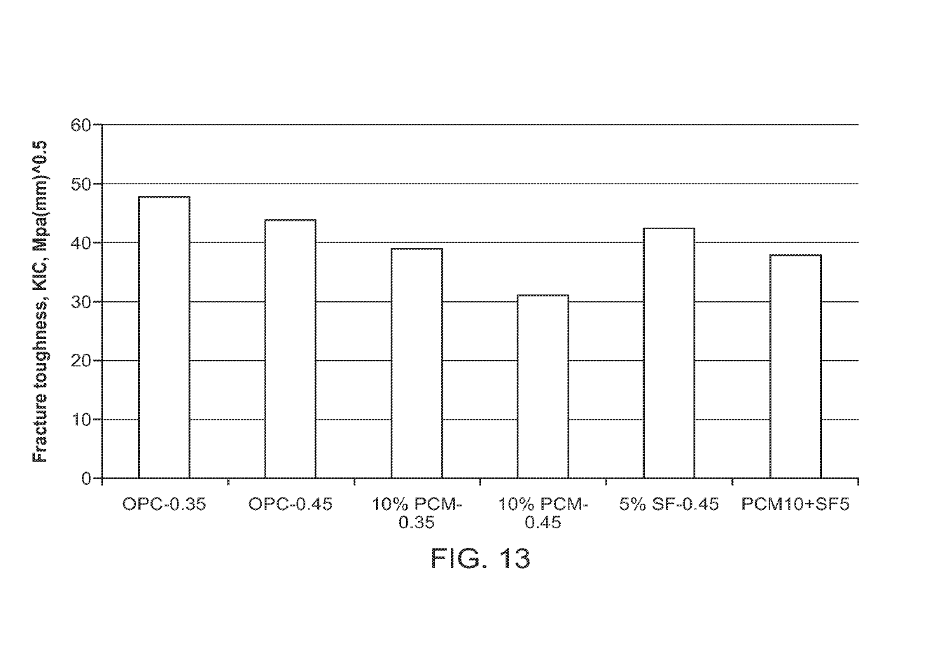

This example demonstrates that the provision of PCM incorporated concrete compositions according to this disclosure is capable of comparable fracture toughness as that of conventional concretes. Such a property is desirable for alleviating cracking risk of a cementitious composition, See, FIG. 13.

### Example 10: Effect of PCMs on Moisture Shrinkage (Paste)

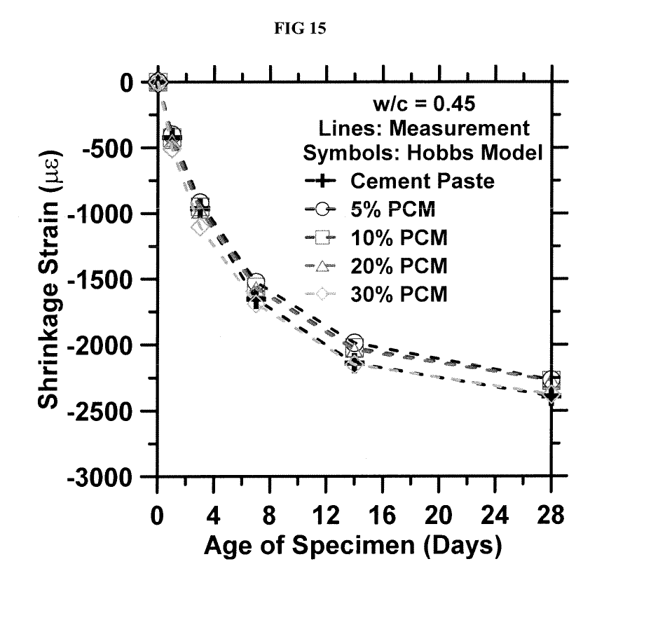

Drying shrinkage is measured as described in ASTM C157. The addition of PCMs does not influence shrinkage. PCM does not restrain overall shrinkage of paste phase. Thus, PCM addition does not alter deformability. In the case of a soft inclusion as relevant for this example, the continuous phase (cement paste), not the dispersed phase (PCM) is noted to control overall behavior. FIG. 15.

### Example 11: Effect on Free (Thermal) Deformations

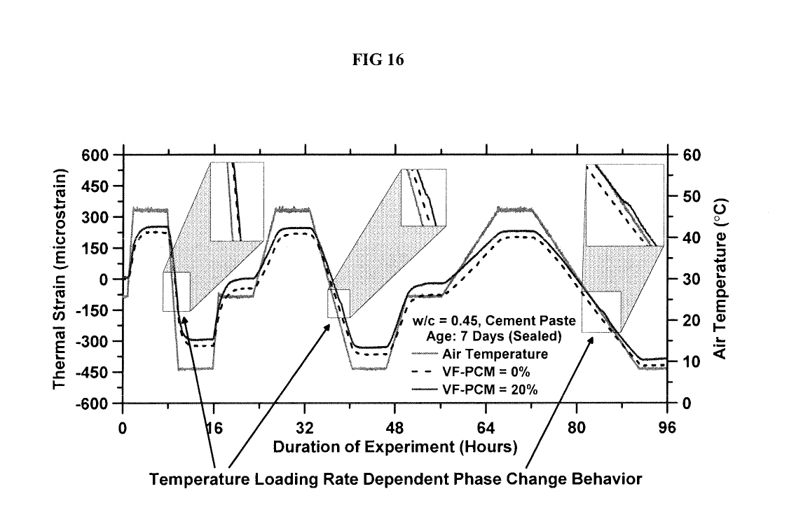

Free deformation is measured under imposed thermal loads. Similar to moisture shrinkage, the PCM composition provided herein behaves like the plain cement paste. The results are shown in FIG. 16, and indicate similar coefficient of thermal expansion (COTE) for plain and PCM loaded pastes. It is contemplated that PCM pastes can have lower thermal stresses as a function of lower stuffiness. However, in agreement with Example 5, the phase change is noted to influence the rate of deformation during cool-down.

### Example 12: Restrained Thermal Cracking Test

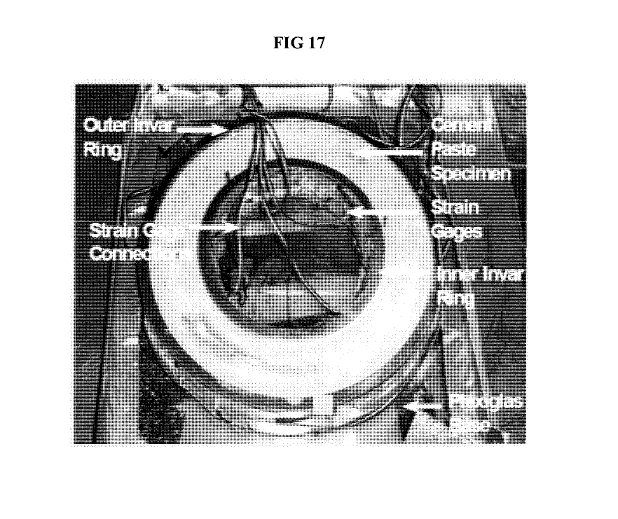

Restrained thermal cracking is tested employing a dual invar setup. See, FIG. 17. Degree of restraint is similar to ASTM C1581 geometry while ensuring the additional provision of tunable and realistic (heat) environments. The ring geometry was used for cement paste and mortar evaluations. Early and later age response is measured. Composition comprising PCM and further optionally comprising quartz are tested.

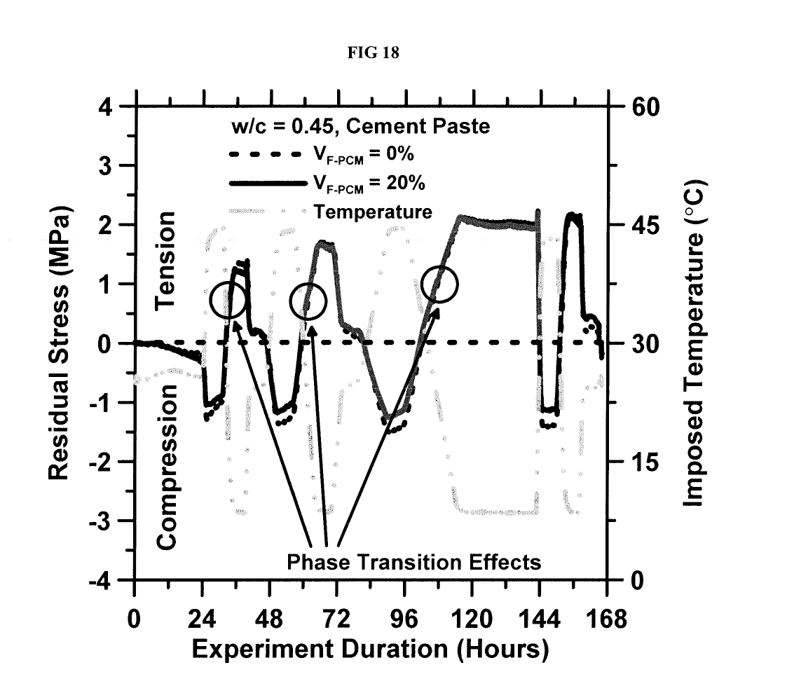

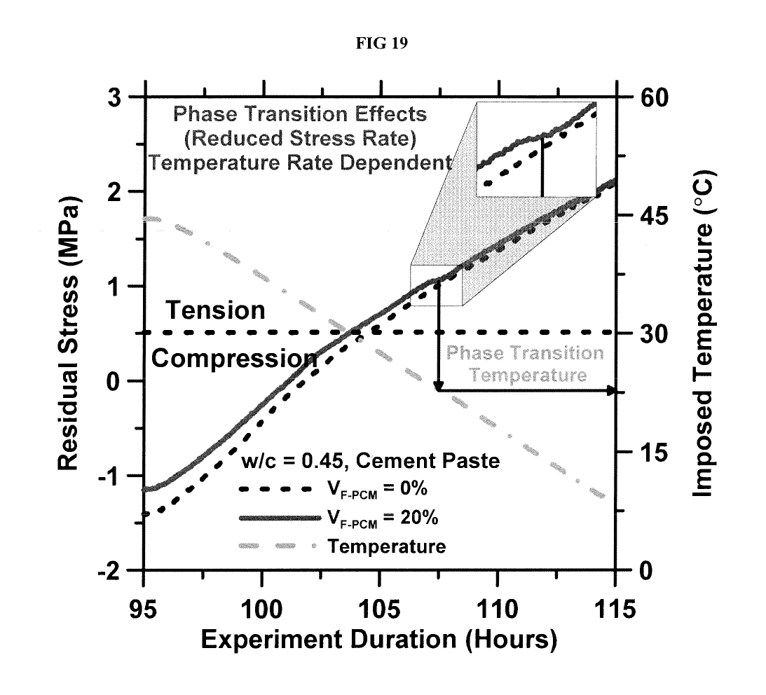

Pastes are exposed to thermal cycles after 24 hours (sealed). Temperature loading at changing rates, is initially faster and then slower with time. PCM pastes shows clear effects of phase transition response, which becomes more pronounced at lower temperature change rates. The results are shown in FIGS. 18 and 19. A similar response is observed in mortars tested after 7 days of aging (hydration). See, FIG. 20.

As used herein, a, an, or the includes reference to a plurality of thing or actions, unless the context indicates otherwise.

Every quantity and range(s) thereof are preceded by the term “about.” As the context indicates, about includes ±2%, ±5%, or 10% of a quantity.

1. A composition comprising concrete and one or more phase change materials (PCMs) for prevention or reduction of thermal damage in a cementitious system, wherein the concrete comprises stratified PCM layers.

2. (canceled)

3. The composition of claim 1, wherein the PCMs in adjacent PCM layers are the same or different.

4. The composition of claim 1, wherein at least one of the PCMs is a liquid PCM that is included in a porous, inorganic, aggregate reservoir.

5. A composition comprising concrete and a phase change material (PCM) for prevention or reduction of thermal damage in a cementitious system, wherein the PCM is included in a porous, inorganic, aggregate.

6. (canceled)

7. The composition of claim 5, wherein the concrete comprises stratified PCM layers.

8. The composition of claim 7, wherein PCMs in adjacent PCM layers are the same or different.

9. The composition of claim 1 or 5, wherein the cementitious system is a hydrated cementitious system.

10. The composition of claim 1 or 5, wherein the composition has a compressive strength of 500-25,000 psi or 1,000-20,000 psi.

11. The composition of claim 1 or 5, wherein the composition further comprises one or more of fly-ash, slag, fuming silica, a porous material, and a non-porous material.

12. The composition of claim 1 or 5, wherein the PCM is an organic PCM or an inorganic PCM.

13. (canceled)

14. The composition of claim 1 or 5, wherein the PCM is a liquid or a solid.

15. (canceled)

16. The composition of claim 1 or 5, wherein the PCM shows a phase transition in the range of −15° C. to 65° C. or in the range of 5° C. to 65° C., or has a phase transition temperature close to the freezing point of water.

17-18. (canceled)

19. The composition of claim 1 or 5, wherein the PCM shows a phase transition enthalpy of 20 joules/g to 500 joules/g or 80 joules/g to 300 joules/g.

20-21. (canceled)
